(19) United States
(12) Patent Application Publication
(10) Pub. No.: US 2007/0179838 A1
(43) Pub. Date: Aug. 2, 2007

(54) Method and system for coupon presentation

(76) Inventor: Joseph Marra, Morganville, NJ (US)

Correspondence Address: MICHAEL I KROLL, 171 STILLWELL LANE, SYOSSET, NY, 11791, US

(21) Appl. No.: 10/894,452

(22) Filed: Jul. 19, 2004

(51) Int. Cl. G06Q 30/00

(52) U.S. Cl. 705/14

(57) ABSTRACT

The present invention discloses a means and system whereby users are afforded redeemable coupons, rebates and gift certificates through display system incorporation of a graphic image of a currency acceptor slot that visually dispenses redeemable coupons, rebates and gift certificates comprised of a coupon image area for graphic images and indicia with the image area defining a selectable link to a predetermined discounted product advertisement. When the coupon, rebate and/or gift certificate is selected the selected item can be stored in a coupon bank to be retrieved at a later time or the hyperlink can be used to retrieve the advertiser's web page.

### BACKGROUND OF THE INVENTION

1. Field of the Invention

The present invention relates generally to distribution systems and, more specifically, to a method and system for distributing, generating and redeeming coupons, rebates and gift certificates through a coupon handler during play of a gaming activity.

There are many on-line wagering games sites where an interested party signs on providing demographic information and acquiring an online ID for participating against other interested parties. Some of these sites have banner ads popping up during users site attendance or provide a user membership area where they can review and select coupons for redemption.

The present invention proposes a means for presenting redeemable coupons, rebates and gift certificates to game participants in a less obtrusive method. The method comprises a graphical image wherefrom redeemable coupons, rebates and gift certificates are visually issued. The player has the option of ignoring the coupon, which will be taken away after a predetermined period of time or clicking on the coupon image, where either the hyperlink is used to retrieve the advertiser's web page or the selected item is placed in a coupon bank for retrieval at a later date. The display of the coupon may incorporate an additional display of a timer denoting a limitation of the coupon offer and may also incorporate a print icon for print a hardcopy of the selected item.

One of the criteria for creating game wagering sites is the inclusion of graphic images of gaming devices whether they be slot machines, roulette tables, black jack, etc. The impetus being to immerse the player in the gaming atmosphere, which is the well spring of the present invention.

Dedicated gaming machines, which are mostly electronic displays and audio systems, have a currency acceptor/validation slot as do other gaming machines and vending machines. The present invention proposes that an image be incorporated into the display of a gaming machine, representative of the currency/validator slot wherefrom coupons will appear to scroll from, thereby providing an unobtrusive method of offering redeemable coupons, rebates and gift certificates in addition to providing online gaming site owners with an avenue for garnering advertising subsidies

One of the difficulties with online advertising is targeting the right clientele. With the birth of the Internet advertisers were provided with a cost effective method of advertising leading to ad-banner laden sites. While this method has proven somewhat successful, the main thrust is now in acquiring demographic data whereby advertisers can target possible clients, which still has the shortcoming that an advertiser has contact information for generating an e-mail advertisement without any guarantee that the prospective client even reads the e-mail due largely to unscrupulous parties spamming e-mail accounts with hundreds of e-mails that lead e-mail servers to dump advertisements into a bulk bin that is easily deleted in mass.

Obviously, providers of goods and services need to advertise and the Internet provides a cost effective vehicle. Discount coupons have also proven to be profitable in enticing consumers to one product or another. This is evident in the number of coupon club distribution sites where consumers provide demographic information and as a member are provided with a list of redeemable coupons. The advantage being that over time a consumer's interests are targeted as opposed to the present shotgun approach of mass e-mailings to known e-mail addresses. This leads to an advantage for those sites that maintain a membership having demographic information and is already involved in electronic funds transfer.

The present invention provides means whereby users are afforded redeemable coupons, rebates and gift certificates through display system incorporation of a graphic image of a currency acceptor slot that visually dispenses redeemable coupons, rebates and gift certificates comprised of a coupon image area for graphic images and indicia with the image area defining a selectable link to a predetermined discounted product advertisement.

2. Description of the Prior Art

There are other methods for processing and dispensing coupons. Typical of these is U.S. Pat. No. 4,882,675 issued to Nichtberger et al. on Nov. 21, 1989.

Another patent was issued to Fite et al. on Sep. 17, 1996 as U.S. Pat. No. 5,557,721. Yet another U.S. Pat. No. 5,710,886 was issued to Christensen et al. on Jan. 20, 1998 and still yet another was issued on Sep. 8, 1998 to Powell as U.S. Pat. No. 5,806,044.

Another patent was issued to Jovicic on Dec. 29, 1998 as U.S. Pat. No. 5,855,007. Yet another U.S. Pat. No. 5,970,469 was issued to Scroggie et al. on Oct. 19, 1999. Another was issued to Powell on Jan. 4, 2000 as U.S. Pat. No. 6,012,038 and still yet another was issued on Mar. 21,2000 to Laor as U.S. Pat. No. 6,041,309.

Another patent was issued to Barnett et al. on Jan. 1, 2002 as U.S. Pat. No. 6,336,099. Yet another U.S. Pat. No. 6,505,773 was issued to Palmer et al. on Jan. 13, 2003. Another was issued to Sjoblom on Aug. 21, 2002 as U.S. Patent No. GB2372367 and still yet another was issued on Aug. 2, 2000 to Tabuteau as French Patent No. FR2812739.

### U.S. Pat. No. 4,882,675

### Inventor: Steven Nichtberger et al.

### Issued: Nov. 21, 1989

Cents-off merchandise coupons are distributed and redeemed immediately and electronically. An electronic display of coupons valid for use in a particular store is presented to customers in that store. When a customer makes a selection of coupons from the display, the selection is recorded. The customer is subsequently identified at a store checkout station as the one who made the selection. In a preferred embodiment, the identification is made by scanning a special card adapted for use with the system. The items purchased in the store by the customer are recorded, and any matches between the coupons selected and the items purchased are determined electronically. The customer is immediately credited in accordance with the terms of the matched coupons. Redeemed coupons are periodically cleared electronically.

### U.S. Pat. No. 5,557,721

### Inventor: Kenneth R. Fite

### Issued: Sep. 17, 1996

A method and apparatus for displaying advertisements and printing coupons on remote systems of a distributed data processing system. A host system downloads display files, command file and transaction files describing the advertisements to be displayed and coupons to be printed to a remote system. The remote system keeps statistics on the number of times each advertisement is displayed and the number of times each coupon is printed, and periodically relays these statistics to the host system.

### U.S. Pat. No 5,710,886

### Inventor: Scott N. Christensen et al.

### Issued: Jan. 20, 1998

A method and apparatus for distributing, generating, and redeeming discount coupons, rebate or gift certificates or the like tracks each coupon using a consumer ID number printed on the coupon. Coupons may be distributed electronically, for example, in the form of a diskette or CD-ROM software. Software on the diskette or CD-ROM may prompt a consumer to call a 1-800 number for a validation number or code. During the phone call, telemarketing personnel may request consumer demographic and or identification information which may be entered into a centralized database. Once the software is validated, a consumer may print out selected coupons displayed on a Graphical User Interface (GUI). Each coupon may be printed only a limited number of times. Each coupon may be imprinted with a consumer ID number, preferably in the form of a bar code. Once redeemed, consumer ID information and coupon information may be retrieved from coupons forwarded to a coupon clearing house. Accurate data may then be produced illustrating which consumers or groups of consumers are redeeming which coupons. Such data may be used for marketing purposes or to generated further diskettes for distribution targeting specific consumers or groups of consumers with specific classes of coupon offerings. The use of a consumer ID number on the coupon may reduce or prevent the fraudulent copying and redemption of coupons, as multiple redemptions of a single coupon by a consumer may be readily detected from data gathered at the brokerage clearing house.

### U.S. Pat. No. 5,806,044

### Inventor: Ken R. Powell

### Issued: Sep. 8, 1998

A system for dispensing and redeeming the electronic discount coupons. The system includes a personal computer (PC) having hardware and software for receiving an electronic coupon from the system of computer networks, translating the received coupon into a binary format, and sending the binary-formatted coupon to a card-writing device. The card-writing device writes the coupon data onto a portable customer card (“smart card”) approximately the size of a credit card. Subsequently, the customer goes to the store with the card. Upon completion of shopping, the customer redeems the electronic coupons at the checkout area, by inserting the card into the checkout station. During checkout, the customer is credited with the value of a coupon when UPC data from a bar code reader corresponds to a coupon stored on the card.

### U.S. Pat. No. 5,885,007

### Inventor: Neboisa Jovicic

### Issued: Dec. 29, 1998

An electronic coupon communication system for generating and redeeming unique product discount coupons over public computer networks such as the Internet. The system comprises a first Internet node, an Internet coupon server and an Internet coupon notification center. The Internet coupon server generates a unique Internet coupon using a coupon generation process. The Internet coupon server accepts an on-line selection of one of the available unique Internet coupons from a user of the Internet node and transmits the coupon back to the user's printing device or e-mail storage. It then records the transaction in its coupon database and notifies the transaction to the Internet Coupon Notification Center. The Internet Coupon Notification Center subsequently records the transaction. Furthermore, a coupon redemption center can electronically verify coupon validity and record coupon redemption by communicating with the Internet Coupon Notification Center.

### U.S. Pat. No. 5,970,469

### Inventor: Michael C. Scroggie et al.

### Issued: Oct. 19, 1999

A system and method for delivering purchasing incentives and a variety of other retail shopping aids through a computer network, such as by E-mail over the Internet or the World Wide Web. Customers (10) of retail stores can establish a bi-directional communication link with the system, log in (16) to the system, and then elect to browse among available purchasing incentive offers (18, 22), or elect to explore other shopping aids, such as a shopping list generator (26), a recipe center (30), or simply elect to claim a product rebate or to receive product information. If the customer elects to have product information or rebate information delivered, only minimal customer identification is required. For purchase incentives redeemable at retail stores, the customer must provide identification information and must also designate a retailer (12) at which the purchasing incentive can be exercised. For receipt of focused incentives based the customer's past shopping behavior, the customer must also supply a unique customer id., such as a check cashing card number or credit card number, used for in-store purchases. For delivery of a product sample, the customer's name and address must be supplied. The system merges this customer-supplied information (270) with other purchase incentive data (272) and creates a printable graphical image of the purchasing incentive (282) for transmission to the customer. In an alternate embodiment of the invention, the purchase incentive is not transmitted directly to the customer. Instead, the terms of the incentive are transmitted electronically to the retail store (310) designated by the customer, who receives either a token (316) to present at the store or an advisory message. In yet another embodiment of the invention, incentives may be targeted to specific consumers based on a consumer purchase history (502), and transmitted to consumers' computers (510) using electronic mail addresses stored in a consumer database (506).

### U.S. Pat. No. 6,012,038

### Inventor: Ken R. Powell

### Issued: Jan. 4, 2000

A system for dispensing and redeeming the electronic discount coupons. The system includes a personal computer (PC) having hardware and software for receiving an electronic coupon from the system of computer networks, translating the received coupon into a binary format, and sending the binary-formatted coupon to a card-writing device. The card-writing device writes the coupon data onto a portable customer card (“smart card”) approximately the size of a credit card. Subsequently, the customer goes to the store with the card. Upon completion of shopping, the customer redeems the electronic coupons at the checkout area, by inserting the card into the checkout station. During checkout, the customer is credited with the value of a coupon when UPC data from a bar code reader corresponds to a coupon stored on the card.

### U.S. Pat. No. 6,041,309

### Inventor: Raviv Laor

### Issued: Mar. 21, 2000

The invention consists of a method and system for enabling and enhancing electronic commerce over a communications channel. The system includes a communication channel coupled to at least two terminals having the ability to send and receive information. Where one terminal is deemed to be the client A, and the other terminal is deemed the server B. Upon receiving a request for information from the client A, the server B transfers the requested information. In addition to the requested information, the server B adds certain additional information either in the form of a coupon C (that can be enciphered), or in the form of a pointer to a coupon database, that allows the client A to be recognized by other servers B′ not necessarily related to the server B, issuing the original information C. Any server(s) B′ that subsequently recognizes client A as the client A makes requests for information to the new server(s) B′ would only have the ability to recognize portions of the information C related to it. When client A makes certain electronic requests from server B′, server B′ will simultaneously make a request to a database on server D that will authenticate the information C that transpired between client A and server B′. Upon authentication and verification by server D, server B′ will allow client A to proceed with any transactions and/or any request for information subject to other criteria of server B′.

### U.S. Pat. No. 6,336,099

### Inventor: Craig W. Barnett et al.

### Issued: Jan. 1, 2002

Provided is a method and system for the electronic distribution of product redemption coupons to remote personal computers located at users' homes. A centrally located repository, such as an online service provider or web site on the Internet, stores packages of coupon data for downloading on demand to the user's computer. The user may view, select, sort and print desired coupons from the downloaded package. The user's demographic as well as coupon selection data is provided back to the online service and coupon distributor and issuers for subsequent marketing analysis. The online service can perform subsequent coupon processing on previously downloaded coupon packages such as variation of discount amounts. The online service provider can also determine how many times a particular coupon was viewed. When the printed coupons are presented at a retail store, the discount is provided to the user. Upon redemption by the store via a coupon redeeming center, transaction data is also supplied to the coupon issuers and distributor for integration into marketing analysis. The electronic coupon system is secure due to the inclusion of user-specific identification indicia printed thereon.

### U.S. Pat. No. 6,505,773

### Inventor: Charles Campbell Palmer

### Issued: Jan. 14, 2003

An online coupon issuing and redemption system and method receives requests for coupons from consumers, presents advertisements and issues coupons to consumers electronically. The system presents advertisements before issuing the coupons, such that an issuer may be assured its targeted consumer are receiving its advertisements. The coupons are issued on a smart card, thereby eliminating a need for paper coupons. The coupons are digitally signed in order to prevent fraud. In order to prevent further fraudulent tampering of coupons, the redemption station includes a tamper-protected coprocessor for performing operations on the coupons. The system further includes capability for the redemption station to link to an issuing station for electronic reimbursements.

### U.S. Patent Number GB2372367

### Inventor: Johan Sjoblom

### Issued: Aug. 21, 2002

A method of generating and redeeming an electronic coupon for a purchaser comprises the steps of generating an electronic coupon at a central server 5, the coupon being associated with a purchaser's identity, sending a request for the coupon from a point-of sale 14 to the central server 5, the request identifying the purchaser, and sending the coupon from the central server 5 to the point-of-sale 14. The step of generating the electronic coupon may be carried out in response to the receipt at the central server 5, or at a site coupled to the central server 5, of a request from the purchaser. The electronic coupon may be generated as a result of an interactive television experience, or from the purchaser carrying out some activity over the internet. The electronic coupon may be generated as a result of a request for the electronic coupon being sent over an interactive channel by a potential purchaser. The interactive channel may comprise a mobile telecommunication network, the purchaser employing a wireless device 7 to send the coupon request.

### U.S. Patent Number FR2812739

### Inventor: Philippe Tabuteau

### Issued: Aug. 02, 2000

The payment procedure commences with the user purchasing coupons carrying a nominated face value. A unique code is printed on the coupon, and the code is masked. When the user wishes to make payment, the code is revealed and transmitted over the Internet to a payment server. The server validates the code to accept payment.

While these systems may be suitable for the purposes for which they were designed, they would not be as suitable for the purposes of the present invention, as hereinafter described.

### SUMMARY OF THE PRESENT INVENTION

A primary object of the present invention is to provide a method and system for displaying redeemable coupons, rebates and gift certificates over the Internet.

Another object of the present invention is to provide a method and system for displaying redeemable coupons, rebates and gift certificates incorporating a graphic image of a currency/acceptor slot.

Yet another object of the present invention is to provide a method and system for displaying redeemable coupons, rebates and gift certificates incorporating a graphic image of a currency/acceptor slot wherefrom said coupon is visually dispensed.

Still yet another object of the present invention is to provide a method and system wherein when a coupon, rebate and gift certificate is selected it can be stored in a coupon bank to be retrieved or redeemed by the user at any time before or after a gaming activity.

Yet another object of the present invention is to provide a method and system for displaying redeemable coupons, rebates and gift certificates incorporating a graphic image of an icon that can be selected to retrieve the coupons, rebates and gift certificates stored in the coupon bank.

Another object of the present invention is to provide a method and system wherein when a coupon, rebate and/or gift certificate is selected the hyperlink can be used to retrieve the advertiser's web page.

Still yet another object of the present invention is to provide a method and system for displaying redeemable coupons, rebates and gift certificates incorporating a graphic image of a currency/acceptor slot and optionally a graphic image for executing a print function.

Another object of the present invention is to provide a method and system for displaying redeemable coupons, rebates and gift certificates incorporating a graphic image of a currency/acceptor slot that can incorporate a timer display for limiting the coupon offer.

Additional objects of the present invention will appear as the description proceeds.

The present invention overcomes the shortcomings of the prior art by providing a means and system whereby users are afforded redeemable coupons, rebates and gift certificates through display system incorporation of a graphic image of a currency acceptor slot that visually dispenses redeemable coupons, rebates and gift certificates comprised of a coupon image area for graphic images and indicia with the image area defining a selectable link to a predetermined discounted product advertisement.

Additionally, when the coupon, rebate and/or gift certificate is selected the selected item can be stored in a coupon bank to be retrieved at a later time or the hyperlink can immediately be used to retrieve the advertiser's web page.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of a slot machine;

FIG. 2 is a diagrammatic view of the present invention;

FIG. 3 is an illustrative view of the present invention in use;

FIG. 4 is an illustrative view of the present invention incorporated into a slot machine display;

FIG. 5 is an illustrative view of the present invention incorporated into a black jack table display;

FIG. 6 is an illustrative view of the present invention illustrating a coupon within a slot machine display;

FIG. 7 is a block diagram of the coupon handler of the present invention;

FIG. 8 is an illustrative view of the present invention having a currency-acceptor slot and a coupon retrieval icon within a gaming apparatus display;

FIG. 9 is an illustrative view of the present invention having a stored coupon retrieval icon and a currency-acceptor slot displaying a dispensed coupon with a print function within a gaming apparatus display;

FIG. 10 is a block diagram of the present invention;

FIG. 11 is a block diagram of the present invention incorporating a timer display function; and

FIG. 12 is a block diagram of the coupon handler processing of the present invention.

### DESCRIPTION OF THE REFERENCED NUMERALS

Turning now descriptively to the drawings, in which similar reference characters denote similar elements throughout the several views, the Figures illustrate the method and system for coupon presentation of the present invention. With regard to the reference numerals used, the following numbering is used throughout the various drawing figures.

10 a method and system for coupon presentation

12 slot machine

14 currency acceptor/validator slot

15 cash out button

16 manufacturer

18 database server

20 internet

22 retailer

24 gaming apparatus

26 communications network

28 coupon dispenser

30 coupon, rebate and gift certificate

31 hyperlink selectable image area

32 user

34 display device

36 gaming display

38 printer

40 hardcopy coupon

42 hardcopy print function

44 print icon

46 initialize print

50 internet

52 Uniform Resource Locator (URL)

54 web site

56 sender information

58 client information

60 coupon information

62 coupon bank

64 coupon handler

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

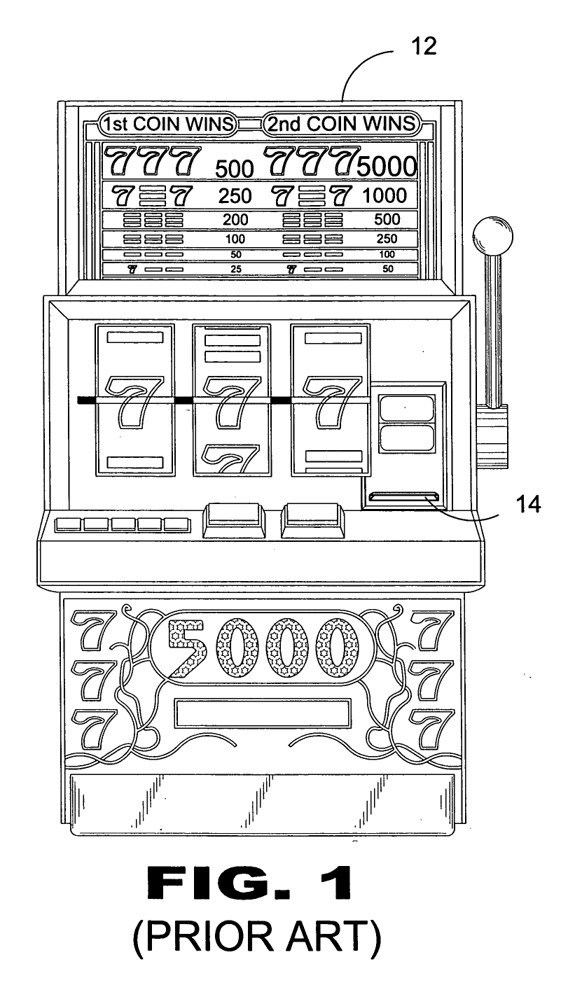

Referring to FIG. 1, shown is an illustrative view of a slot machine. Dedicated gaming machines 12 have a currency acceptor/validation slot 14, as do other gaming and vending machines 12. The present invention proposes that an image be incorporated into the graphical game-apparatus image representative of the currency/validator slot wherefrom coupons will appear to scroll from, thereby providing an unobtrusive method of offering redeemable coupons, rebates and gift certificates in addition to providing online gaming site owners with an avenue for garnering advertising subsidies

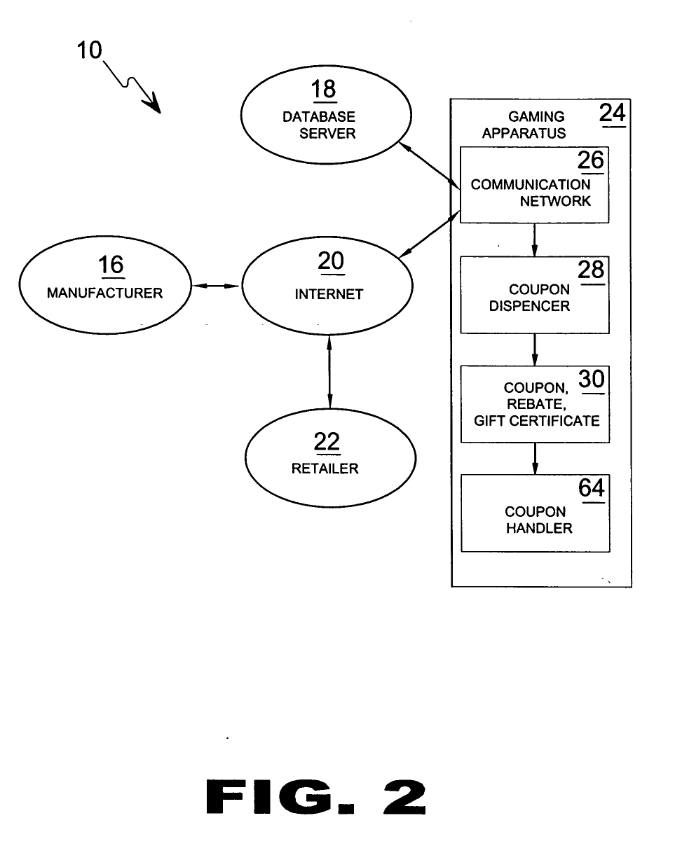

Referring to FIG. 2, shown is a diagrammatic view of the present invention. The present invention 10 discloses a means for presenting redeemable coupons, rebates and gift certificates 30 to game participants in a less obtrusive method. The method comprises a graphical image 28 wherefrom redeemable coupons 30 are visually and randomly issued. The player has the option of ignoring the coupon, which will be taken away after a predetermined period of time, or clicking on the coupon, rebate or gift certificate image 30, which will be processed by the coupon handler 64. The coupon handler 64 will result in either storing the hyperlink for later processing or immediately retrieving the advertisers 16, 18, 22 web page through the Internet 20.

One of the difficulties with online advertising is targeting the right clientele. With the birth of the Internet 20 advertisers 16, 18, 22 were provided with a cost effective method of advertising leading to ad-banner laden sites. While this method has proven somewhat successful, the main thrust is now in acquiring demographic data whereby advertisers 16, 18, 22 can target possible clients, which still has the shortcoming that an advertiser has contact information for generating an Internet e-mail advertisement 20 without any guarantee that the prospective client even reads the e-mail due largely to unscrupulous parties spamming e-mail accounts with hundreds of e-mails that has led e-mail servers to dump advertisements into a bulk bin that is easily deleted in mass.

Providers of goods and services need to advertise and the Internet provides a cost effective vehicle. Discount coupons, rebates and gift certificates have also proven to be profitable in enticing consumers to an advertiser's product. This is evident in the number of coupon club distribution sites where consumers provide demographic information and as a member are provided with a list of redeemable coupons. The advantage being that over time a consumer's interests are targeted as opposed to the present shotgun approach of mass e-mailings to known e-mail addresses. This leads to an advantage for those sites that maintain a membership having demographic information and is already involved in electronic funds transfer, such as online gaming. A PC currently serves as the gaming apparatus 24 having an Internet connection provided by communication network 26 for logging onto the online gaming site.

The present invention displays a graphic image of a currency acceptor slot 28 that visually dispenses redeemable coupons, rebates and gift certificates 30 comprised of a coupon 30 image area for graphic images and indicia with the image area defining a selectable link to a predetermined discounted product advertisement.

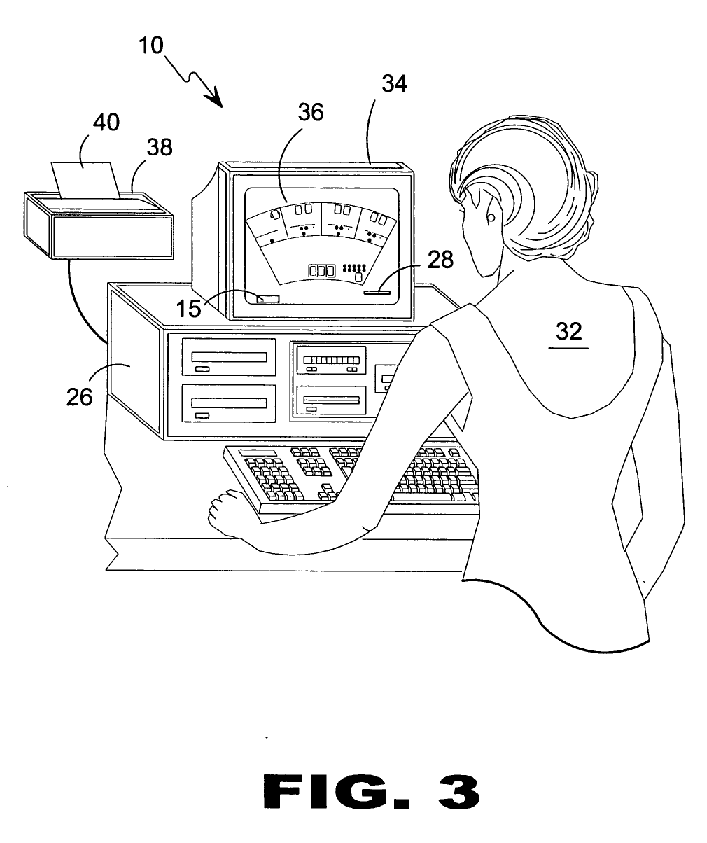

Referring to FIG. 3, shown is an illustrative view of the present invention in use. The present invention 10 is a method and system for distributing, generating and redeeming coupons, rebates and gift certificates 30 during play of an online gaming activity 36. The software logic determines when and which coupon, rebate or gift certificate 30 is displayed scrolling from coupon dispenser 28 that forms an integral image with the gaming-apparatus image 36 displayed on graphic monitor 34. The player 32 has the option of ignoring the coupon, rebate or gift certificate image or clicking on the coupon 30 image scrolling from the currency acceptor slot 28, which result in either the retrieval of the hyperlinked web page or storage of the selected item in a coupon bank 62 for retrieval, through use of a retrieval icon 15, at a later time. The display monitor 34 is connected to communications device 26 providing access to the Internet and/or a printing device 38 for printing a hardcopy 40 of selected item 30.

As illustrated, the present invention provides means whereby users 32 are afforded redeemable coupons, rebates and gift certificates 30 through display system 34 executing gaming application 36 that incorporates graphic image 28 of a currency acceptor slot that visually dispenses redeemable coupons, rebates and gift certificates 30 comprised of a coupon image area for graphic images and indicia with the image area defining a selectable link to a predetermined discounted product advertisement.

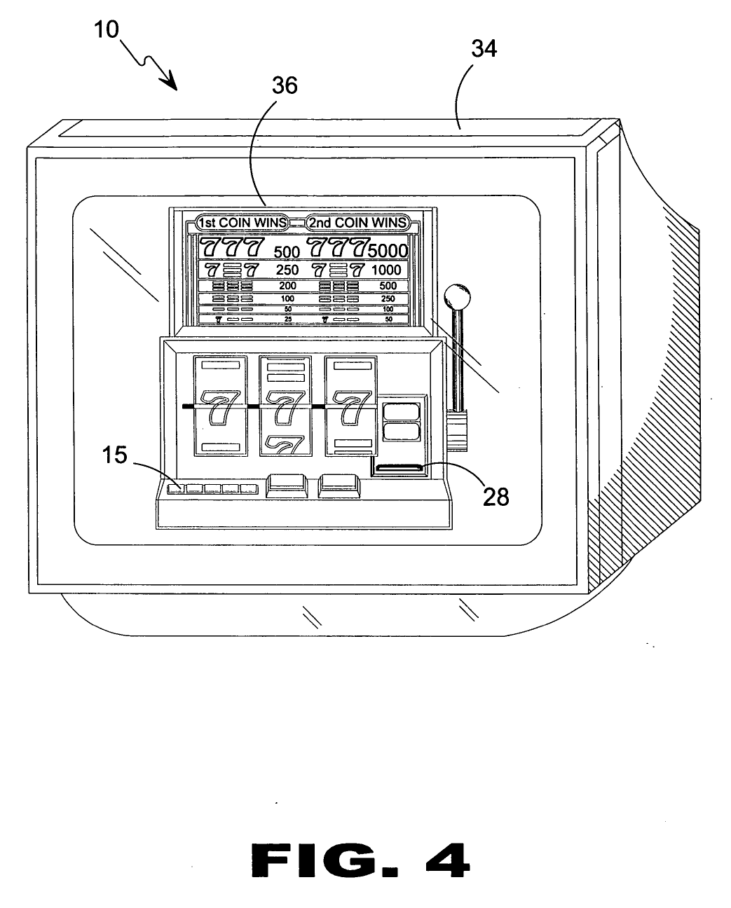

Referring to FIG. 4, shown is an illustrative view of the present invention incorporated into a slot machine gaming display 36. The present invention 10 is a method and system for distributing, generating and redeeming coupons, rebates and gift certificates 30 during play of an online gaming activity 36, such as the slot machine illustrated. The software logic determines when and which coupon is displayed scrolling from coupon dispenser 28 that forms an integral image with the gaming-apparatus image 36 displayed on graphic monitor 34 that when selected will be processed by the coupon handler 64. The player 32 has the option of ignoring the coupon, rebate or gift certificate image or clicking on the coupon 30 image scrolling from the currency acceptor slot 28, which result in either retrieval of the hyperlinked web page or storage of the selected item in a coupon bank 62 that can be retrieved through use of a retrieval icon 15, at any time before or after game.

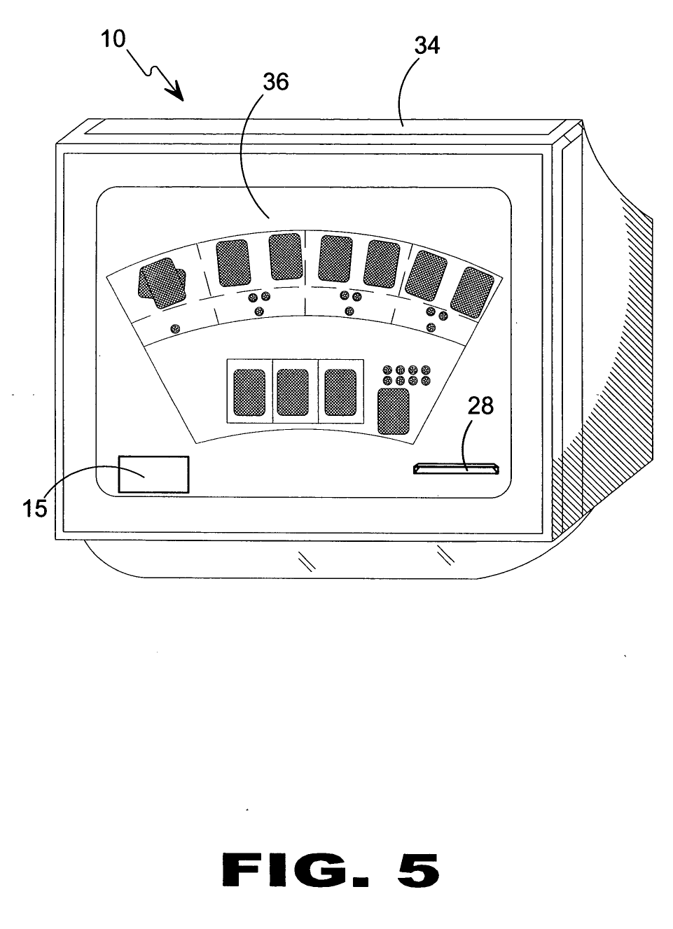

Referring to FIG. 5, shown is an illustrative view of the present invention incorporated into a card game application 36. The present invention 10 is a method and system for distributing, generating and redeeming coupons, rebates and gift certificates 30 during play of an online gaming activity 36 upon display device 34. The coupon handler 64 determines when and which coupon is displayed scrolling from coupon dispenser 28 that forms an integral image with the gaming-apparatus image 36 displayed on graphic monitor 34. Should the coupon, rebate or gift certificate 30 image area be selected, the coupon handler 64 will process the selected item 30 either immediately or store the selected item within a coupon bank 64 for later retrieval through selection of retrieval icon 15.

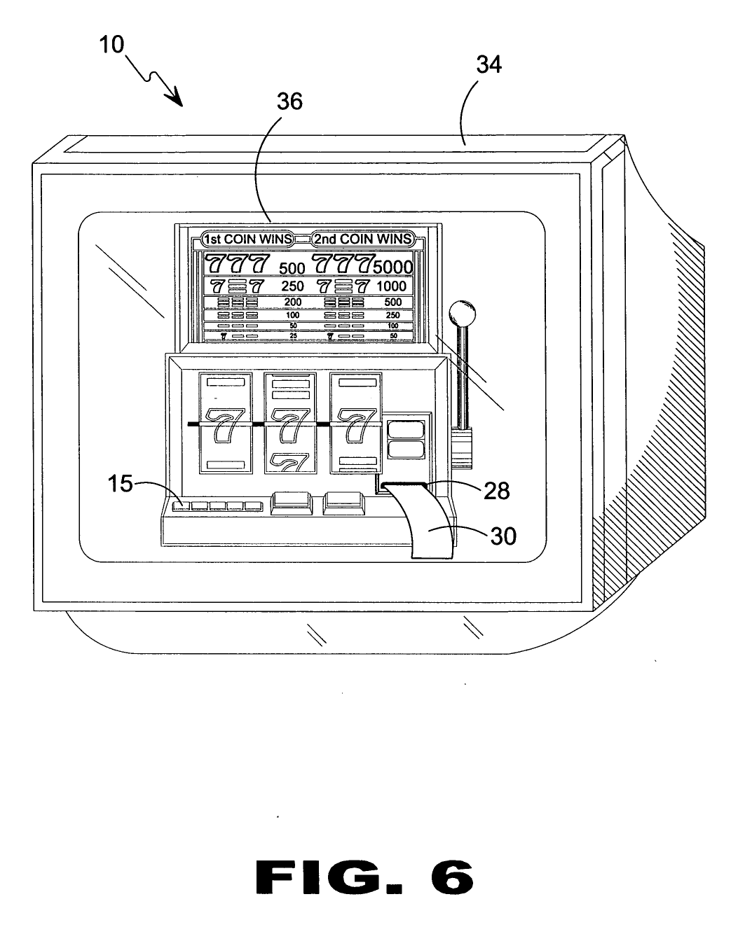

Referring to FIG. 6, shown is an illustrative view of the present invention illustrating a coupon within a slot machine gaming display 36 upon display monitor 34. The present invention 10 is a method and system for distributing, generating and redeeming coupons, rebates and gift certificates during play of an online gaming activity 36, such as the slot machine illustrated. The software logic determines when and which coupon 30 is displayed scrolling from coupon dispenser 28 that forms an integral image with the gaming-apparatus image 36 displayed on graphic monitor 34.

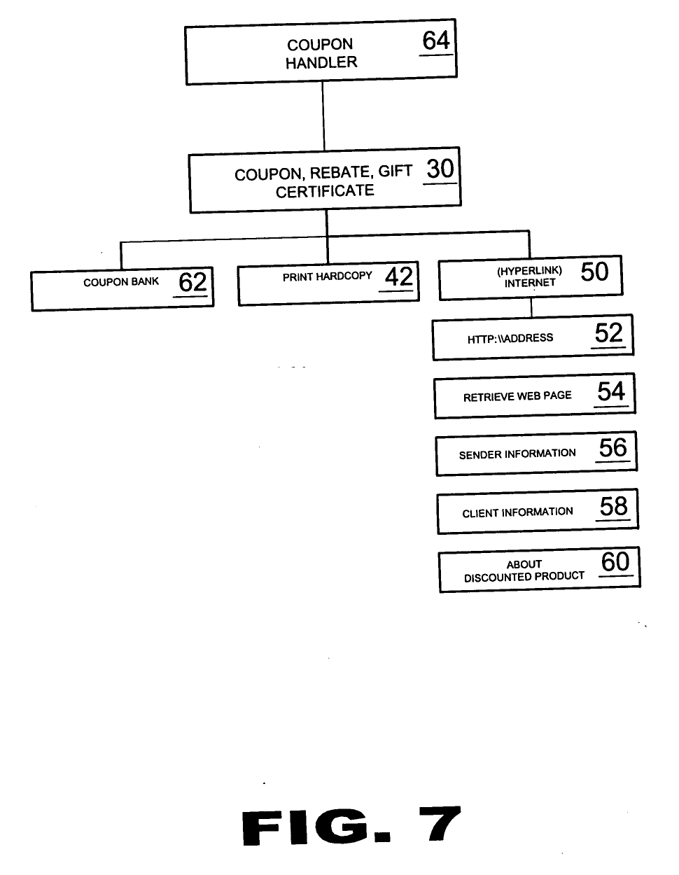

Referring to FIG. 7, shown is a block diagram of the coupon handler of the present invention. The present invention is a method and system for distributing, generating and redeeming coupons, rebates and gift certificates during play of a gaming activity. The coupon handler determines when a coupon 30 is displayed to the user and what processing is to occur if the coupon image area 30 is selected. The player has the option of clicking on the coupon image 30 scrolling from the currency acceptor slot. The coupon area 30 serves as an Internet hyperlink 50 that when selected can either be used to access the Internet 20 to retrieve the advertisers 16, 18, 22 web page or saved in a coupon bank 62 for retrieval at a later time through selection of cash out icon 15. Gaming apparatus image 36 may also include an icon for executing a print function 42. The print function 42 is initiated by clicking on the print icon 44 that executes the printer utility 46 resulted in a hardcopy of the redeemable coupon 40. As a hyperlink, additional coupon information 54 is retrieved. The “get” for the web page can include information germane to redirection accounting, such as sender information 56 and/or client information 58. Once retrieved the additional coupon information 60 is displayed.

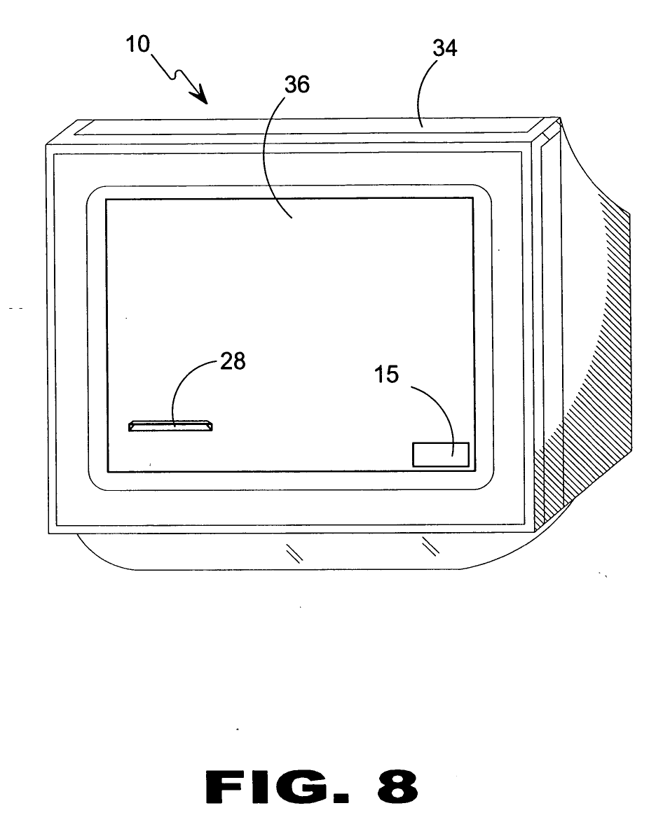

Referring to FIG. 8, shown is an illustrative view of the present invention having a currency-acceptor slot 28 and stored coupon retrieval function 15 within a gaming apparatus display 36. The present invention provides means whereby users 32 are afforded redeemable coupons 30 through gaming apparatus display 36 incorporating a graphic image 30 of a currency acceptor slot 28 that visually dispenses redeemable coupons, rebates and gift certificates 30 comprised of a coupon image area 31 for display of various graphic images and/or indicia with the image area 31 defining a selectable link to access the coupon, rebate, or gift certificate 30 claim process of advertisers 16, 18, 22.

The player has the option of clicking on the coupon image 30 scrolling from the currency acceptor slot. The coupon area 30 serves as an Internet hyperlink 50 that when selected can either be used to access the Internet 20 to retrieve the advertisers 16, 18, 22 web page or saved in a coupon bank 62 for retrieval at a later time through selection of cash out icon 15.

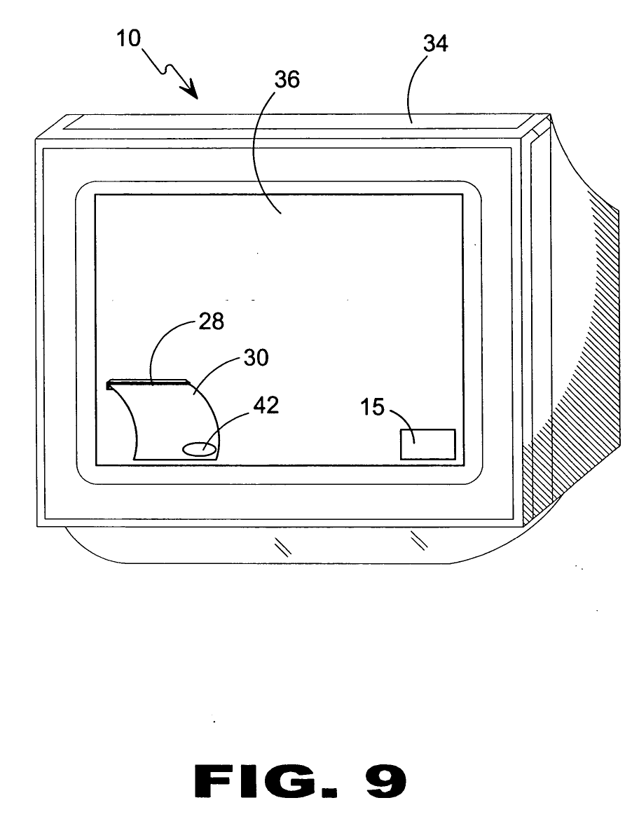

Referring to FIG. 9, shown is an illustrative view of the present invention having a currency-acceptor slot displaying a dispensed coupon with a print function within a gaming apparatus display. The present invention provides means whereby users are afforded redeemable coupons, rebates and gift certificates 30 through display system 28 incorporating a graphic image of a currency acceptor slot 28 that visually dispenses said redeemable coupons, rebates and gift certificates. that additionally can display an icon for executing a print function.

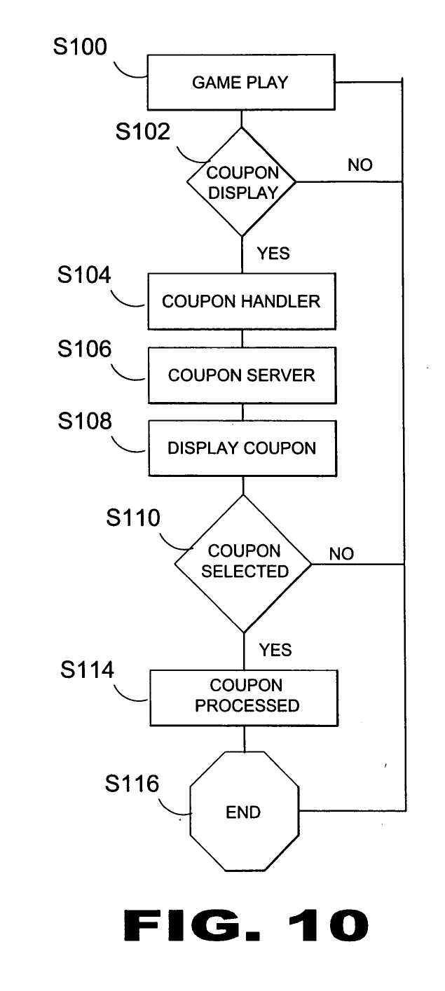

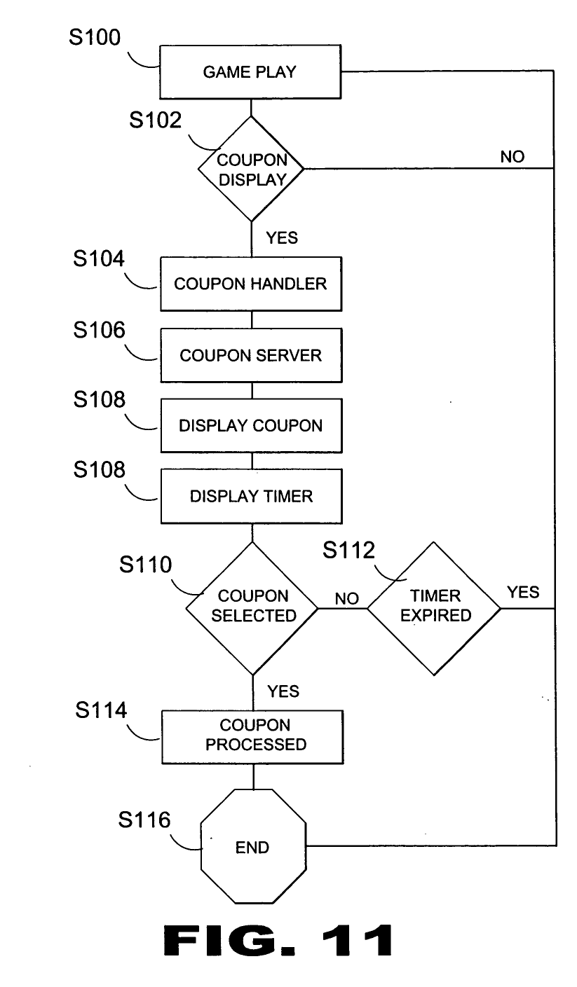

Referring to FIG. 10, shown 10 is a flow chart of the present invention. The present invention is a method and system for distributing, generating and redeeming coupons, rebates and gift certificates during play of a gaming activity, as shown in Step S100. The software logic determines when a coupon is displayed, as shown in Step S102. Randomly or by design a coupon is retrieved, as stated in Step S104 through coupon server, as shown in Step S106 and displayed to the user as shown in Step S108. The player has the option of clicking on the coupon image scrolling from the currency acceptor slot, as shown in Step S110. If selected the coupon will be process, as shown in step S114. Upon termination of processing, shown in step S116 execution can continue with game play, as shown in step S100. Referring to FIG. 11, shown is a block diagram of the present invention incorporating a timer function. The present invention is a method and system for distributing, generating and redeeming coupons, rebates and gift certificates during play of a gaming activity, as shown in Step S100. The software logic determines when a coupon is displayed, as shown in Step S102. Randomly or by design a coupon is retrieved, as stated in Step S104 through coupon server, as shown in Step S106 and displayed to the user as shown in Step S108. The player has the option of clicking on the coupon image scrolling from the currency acceptor slot, as shown in Step S110. As shown in step S112, a timer display can be incorporated to limit the offer. If selected within the specified time frame, coupon claim processing will proceed, as shown in step S114. Upon termination of processing, shown in step S116 execution can continue with game play, as shown in step S100.

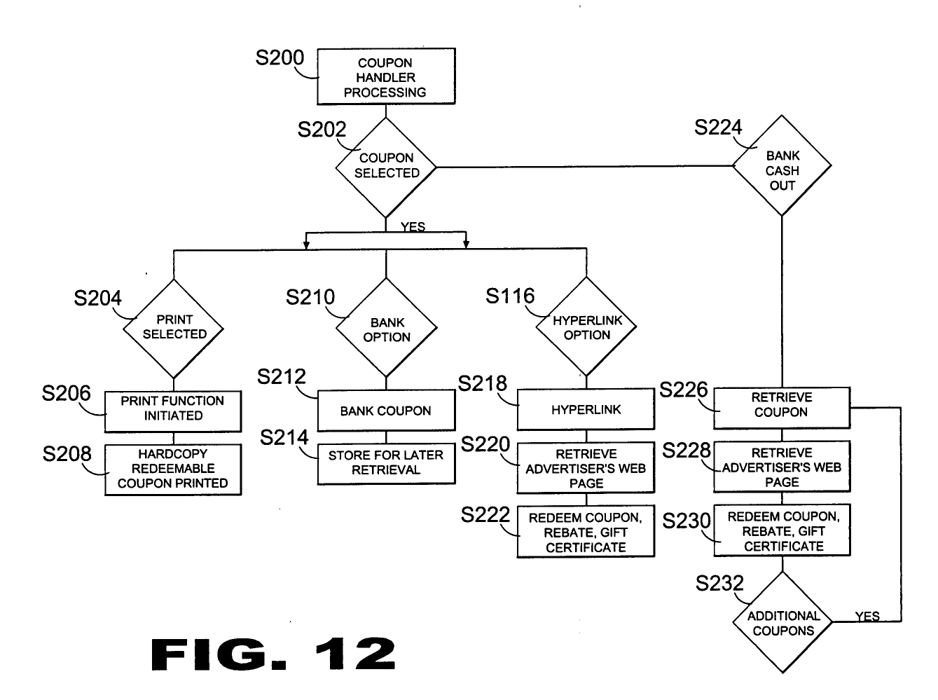

Referring to FIG. 12, shown is a flow chart of the coupon handler of the present invention. The present invention is a method and system for distributing, generating and redeeming coupons, rebates and gift certificates during play of a gaming activity. The coupon handler determines when a coupon is displayed to the user, shown in step S200, and what processing is to occur when the coupon is selected, as shown in step S202. Initiating a print function, shown in step S204, executed a print function, as shown in step S206 resulting in a hardcopy of the redeemable coupon, rebate or gift certificate, shown in step S208. Bank option process, as shown in step S210, stores the coupon link in a bank coupon, as shown in step S212 for later retrieval through a bank coupon retrieval process. shown in step S214. Processing using a hyperlink option, as shown in step S116 will access the Internet using the provided hyperlink, as shown in step S218. Processing continues as the advertiser's web page is retrieved, as shown in step S220, whereupon further claim process would occur, as shown in step S222. Extending the bank coupon option requires the retrieval of the stored coupons, rebates and/or gift certificates, which is initiated through selection of the cash out process, as shown in step S224. Processing continues with the retrieval of a coupon, as shown in step S226 with the hyperlink being used to access the Internet and retrieve the advertisers web page, as shown in step S228. Further claim processing can occur, as shown in step S230. If there are other coupons, rebates, gift certificates in the coupon bank, the aforementioned processing in step S226 through step S230 would be repeated for each, as shown in step S232.

As illustrated in FIGS. 1 through FIG. 12, the present invention provides means whereby users are afforded redeemable coupons, rebates and gift certificates through display system incorporation of a graphic image of a currency acceptor slot that visually dispenses redeemable coupons, rebates and gift certificates comprised of a coupon image area for graphic images and indicia with the image area defining a selectable link to a predetermined discounted product advertisement.

What is claimed is new and desired to be protected by Letters Patent is set forth in the appended claims:

1. a system of providing redeemable coupons during the execution of a computer application comprising:
a) a computer running the computer application;
b) a display monitor for displaying the computer application;
c) a coupon provided by a third party;
d) said computer application comprising a gaming application;
e) said computer application displaying a slot comprised of pairs of spaced apart borders affixed at their distal ends;
f) said slot having the appearance of a vending currency acceptor slot; and
g) said computer application having a coupon handler.

2. The system as recited in claim 1, wherein said coupon handler comprises:
a) an initialization process;
b) a display process; and
c) an executable process.

3. The system as recited in claim 2, wherein said initialization process comprises:
a) initiating a get coupon
b) retrieving a coupon from a coupon file; and
c) said coupon file accessible through a communications network.

4. The system as recited in claim 2, wherein said display process comprises;
a) initiating a put coupon
b) displaying on said monitor the retrieved coupon emanating from the currency acceptor slot; and
c) defining on said monitor a digitally displayed coupon space selectable by a computer application user.

5. The system as recited in claim 4, wherein said display process includes defining a coupon print-process space selectable by a computer application user on said monitor.

6. The system as recited in claim 5, wherein said display process includes defining a coupon print-process space selectable by a computer application user contained within the digitally displayed coupon space.

7. The system as recited in claim 5, wherein said display process includes defining a coupon print-process space selectable by a computer application user selectively positioned outside of the digitally displayed coupon space.

8. The system as recited in claim 2, wherein said execution process comprises;
a) using a pointing device to click within the digitally displayed coupon space;
b) retrieving a web page through the communications network; and
c) displaying the retrieved web page on the applications display monitor.

9. The system as recited in claim 8, wherein said execution process includes defining a coupon hardcopy-print process space, selectable by a computer application user.

10. The system as recited in claim 9, wherein said execution process includes defining a coupon hardcopy-print process space, selectable by a computer application user, contained within the digitally displayed coupon space.

11. The system as recited in claim 9, wherein said execution process includes defining a coupon hardcopy-print process space, selectable by a computer application user, selectively positioned outside the digitally displayed coupon space.

12. The system as recited in claim 8, wherein said hardcopy-print process includes printing a hardcopy of said redeemable coupon.

13. The system as recited in claim 8, wherein said execution process includes defining a coupon limit-process for displaying therein a starting time digital display.

14. The system as recited in claim 13, wherein said starting time moves to a predetermined ending time whereupon the digital display coupon space is not selectable.

15. a method of dynamically providing redeemable coupons during the execution of a computer application comprising:
a) running the computer application;
b) displaying a currency acceptor slot;
c) retrieving a coupon from a coupon source;
d) displaying a coupon emanating from the currency acceptor slot;
e) defining a digitally displayed coupon space selectable by a computer application user.

16. The method as recited in claim 15 further comprising a selectable coupon print process for obtaining a hardcopy of the coupon.

17. The method as recited in claim 15 further comprising a digital display timer for limiting the availability of the redeemable coupon.

18. a system of providing redeemable coupons during the execution of a computer application comprising:
a) a computer running the computer application;
b) a display monitor for displaying the computer application;
c) a coupon provided by a third party;
d) said computer application comprising a gaming application;
e) said computer application displaying a slot comprised of pairs of spaced apart borders affixed at their distal ends;
f) said slot having the appearance of a vending currency acceptor slot;
g) said computer application having a coupon handler; and
h) said computer application displaying an icon for retrieval of a stored coupon claim processing link.

19. The system as recited in claim 18, further comprising computer instructions for storing coupon claim processing links.

20. The system as recited in claim 19, wherein said storage function forms a coupon bank wherefrom execution of a retrieval process will retrieve the coupon claim processing link to initiate coupon claim processing.
